(19) United States
(12) Patent Application Publication
(10) Pub. No.: US 2012/0215726 A1
(43) Pub. Date: Aug. 23, 2012

(54) PRICE SETTING CIRCUITRY FOR VENDING MACHINES

(75) Inventor: Ming Ip, West Hempstead, NY (US)

(73) Assignee: GENESIS MANUFACTURING, INC., West Hempstead, NY (US)

(21) Appl. No.: 13/030,190

(22) Filed: Feb. 18, 2011

(51) Int. Cl. G06Q 90/00; B65D 83/00; G07D 1/06; G06F 9/00

(52) U.S. Cl. 705/500; 194/217; 221/97; 453/2

(57) ABSTRACT

Systems and methods for setting the prices of merchandise in vending machines are provided. According to some implementations, an electrical circuitry may be provided for vending merchandise. The electrical circuitry may comprise an actuator driver configured to control a dispensing mechanism associated with a vending unit for dispensing merchandise from the vending unit to a buyer. The electrical circuitry may also include an electronic price setting circuit configured to individually set the price for the merchandise of the vending unit. The electronic price setting device may include at least one manually adjustable component associated with each vending unit. A currency acceptor of the electrical circuitry is configured to accept currency from the buyer. An electronic control unit may be arranged in electrical communication with the actuator driver, electronic price setting circuit, and currency acceptor.

### TECHNICAL FIELD

The present disclosure generally relates to vending machines, and more particularly relates to circuits for setting the prices for the merchandise dispensed by vending machines.

### BACKGROUND

Vending machines are commonly installed in public or well-populated areas around the world and allow buyers to purchase goods without the need for a seller to be present. Various types of merchandise may be purchased from vending machines, including candy, soda, bottled water, snacks, gum, toys, and other items that might typically have a relatively long shelf life.

Some vending machines comprise a transparent globe for holding bulk items such as gumballs. In operation, a buyer inserts a coin (e.g., a quarter) in a coin receptacle and turns a crank, which causes a single item in the globe to be moved to the top of a chute leading down to an opening where the buyer can retrieve the item. These types of vending machines may have a fixed mechanical means for accepting one or more coins, but they have the disadvantage of prohibiting the owner from changing the price for purchasing the merchandise without complex alterations to the machine. Therefore, the owner may not be able to adjust the prices for merchandise to keep up with factors such as inflation, changes in supply and demand, or other economic or marketing trends.

Other vending machines may comprise an array of dispensing coils arranged horizontally, where each coil holds one type of item and each turn of the coil holds a single one of these items. In operation, a buyer inserts currency in a bill acceptor and/or coin acceptor to cover the cost for the desired item. Then the buyer presses numbers and/or letters on a keypad to select the desired item. The machine sends a signal to the selected coil causing it to rotate one complete cycle and forcing the forward-most item to be pushed off a ledge into a bin where the buyer can retrieve the item. The keypads for these and other similar types of vending machines not only allow buyers to make item selections, but they may also be configured to allow an operator to program the prices for the items. Although the prices of the various items can be changed for these types of machines, the process of changing the prices can be a complex task. Often, the operator must receive training and/or must use a manual to program the machines for setting prices for each item as needed.

### SUMMARY

The present disclosure describes systems and methods for enabling an operator to set the prices for merchandise to be dispensed from a vending machine, e.g. a bulk vending machine. In some implementations, a vending machine may be configured with a plurality of vending units. Each of the vending units includes a container configured to store merchandise specific to the respective vending unit. Also, each vending unit includes an actuator configured to dispense the merchandise from the container to a buyer. The vending machine includes a plurality of price setting circuits that are inaccessible to the public. Each price setting circuit is configured to set the price for the merchandise for a respective vending unit. Also, each price setting circuit includes at least one switch having a manually adjustable component. In addition, the vending machine contains a currency acceptor configured to accept currency from the buyer and a control unit in communication with the price setting circuits and currency acceptor. The control unit is configured to actuate the actuator of a selected vending unit when a received amount of currency by the currency acceptor is equal to or greater than the price set for the selected vending unit.

According to other implementations of the present disclosure, an electrical circuitry is provided for vending merchandise. The electrical circuitry comprises an actuator driver configured to control an actuator associated with a vending unit for dispensing merchandise from the vending unit to a buyer. The electrical circuitry also includes an electronic price setting circuit configured to set the price for the merchandise of the vending unit. The electronic price setting device includes at least one manually adjustable component. A currency acceptor of the electrical circuitry is configured to accept currency from the buyer. An electronic control unit is arranged in electrical communication with the actuator driver, electronic price setting circuit, and currency acceptor. The electronic control unit is configured to receive an actuation signal and is further configured to provide a control signal to the actuator driver when an amount of currency received by the currency acceptor is equal to or greater than the price set for the vending unit.

Some of the embodiments of the present disclosure are directed to methods of setting prices for a vending machine. According to one embodiment, a method includes enabling an authorized operator to access a secured interior portion of the vending machine. The vending machine comprises a plurality of vending units for dispensing various types of merchandise. The method also includes enabling the authorized operator to manipulate one or more mechanical elements of a first set of switches of a first price setting circuit for a first vending unit. As needed, the method repeats the process of enabling the authorized operator to manipulate one or more mechanical elements of another set of switches of another price setting circuit for another vending unit. This is repeated until the prices for the plurality of vending units are set appropriately. The method also includes enabling the authorized operator to secure the interior portion of the vending machine to prevent unauthorized access.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure and are not necessarily drawn to scale. Corresponding features and components throughout the figures may be designated by matching reference characters for the sake of consistency and clarity.

FIG. 1 is a diagram showing a front view of a vending machine according to various implementations of the present disclosure.

FIG. 2 is a block diagram showing vending circuitry according to various implementations of the present disclosure.

FIGS. 3A through 3F are diagrams showing various embodiments of switches that may be used in the price setting circuits shown in FIG. 2.

FIGS. 4A through 4C are diagrams illustrating various switch combinations for setting a range of prices, according to various implementations of the present disclosure.

FIGS. 5A through 5C are schematic diagrams illustrating embodiments of the price setting circuits shown in FIG. 2, according to various implementations of the present disclosure.

FIG. 6 is a diagram illustrating a view of a top side of a dispensing mechanism for a vending machine, according to various implementations of the present disclosure.

FIG. 7 is a diagram illustrating a view of a bottom side of the dispensing mechanism of FIG. 6, according to various implementations of the present disclosure.

FIG. 8 is flow diagram showing an embodiment of a method for setting prices for a vending machine, according to various implementations of the present disclosure.

### DETAILED DESCRIPTION

The present disclosure describes different types of vending machines (e.g., bulk vending machines) for dispensing merchandise (e.g., bulk type items such as gumballs, rubber balls, candy, etc.). According to the implementations of the present disclosure, the vending machines described herein include price setting controls for setting the price for each individual type of merchandise. Instead of requiring an operator to conduct complex programming processes to adjust the prices, as is common in conventional vending machines, the present disclosure allows an operator to adjust prices in an easy, intuitive manner.

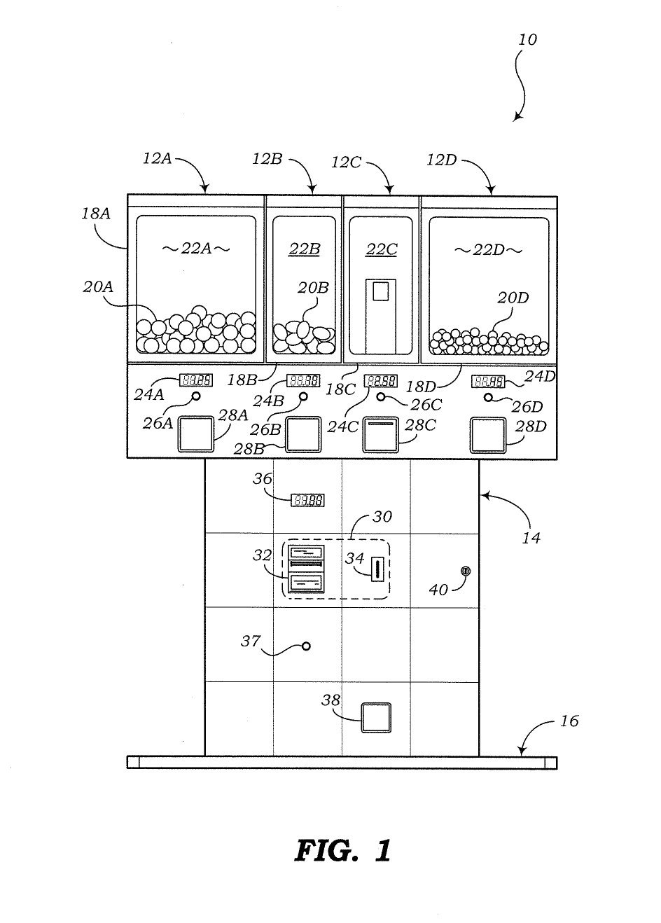

FIG. 1 is a diagram of a front view of an embodiment of a vending machine 10 according to various implementations of the present disclosure. The vending machine 10 may include any number of vending units 12, wherein, in some embodiments, the vending machine 10 may contain a single vending unit 12 and, in other embodiments, it may contain up to eight or more vending units 12, depending on the design. As illustrated in this particular embodiment, however, the vending machine 10 includes four vending units 12A, 12B, 12C, and 12D. The vending machine 10 also includes a pedestal unit 14 that supports the vending units 12 at an appropriate height. The pedestal unit 14 may incorporate much of the electrical circuitry of the vending machine 10. A base unit 16 is located at the bottom of the vending machine 10 for structural stability.

Each of the vending units 12A, 12B, 12C, and 12D includes a respective container 18A, 18B, 18C, and 18D, each configured to store a certain type of merchandise 20A, 20B, 20C, and 20D. The type of merchandise 20 may be selected for each vending unit 12 based on the size or shape of dispensing mechanisms or other characteristics of the particular vending unit 12. For example, the merchandise 20 may include bulk items, such as gumballs, rubber balls, candy, plastic shells containing various items (e.g., candy, toys, key chains, or other items that may fit inside the shells), or other items that may conform to particular size or shape specifications of the respective vending unit 12.

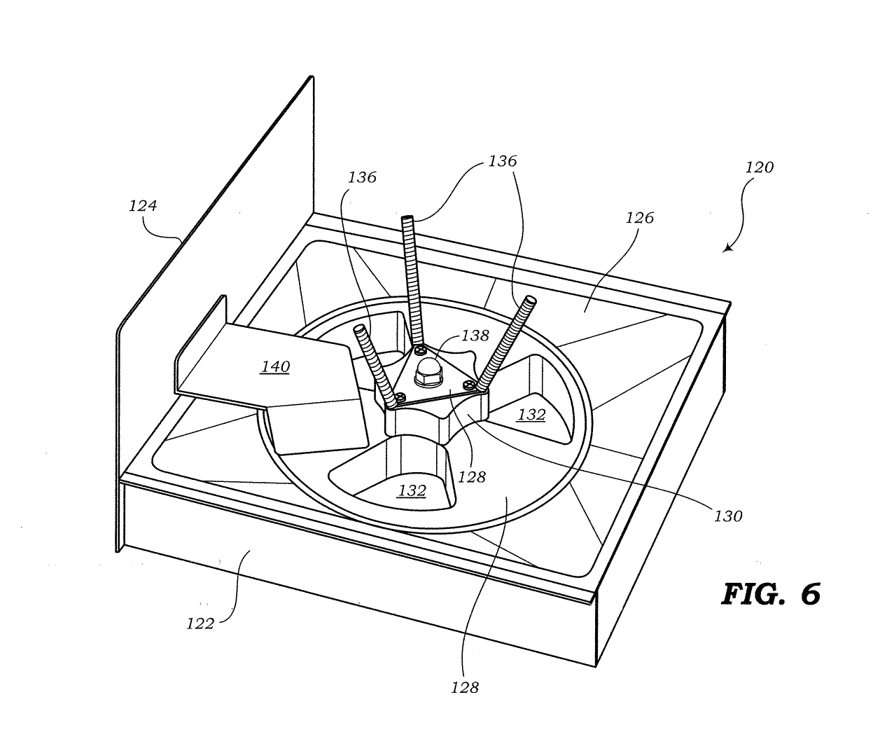

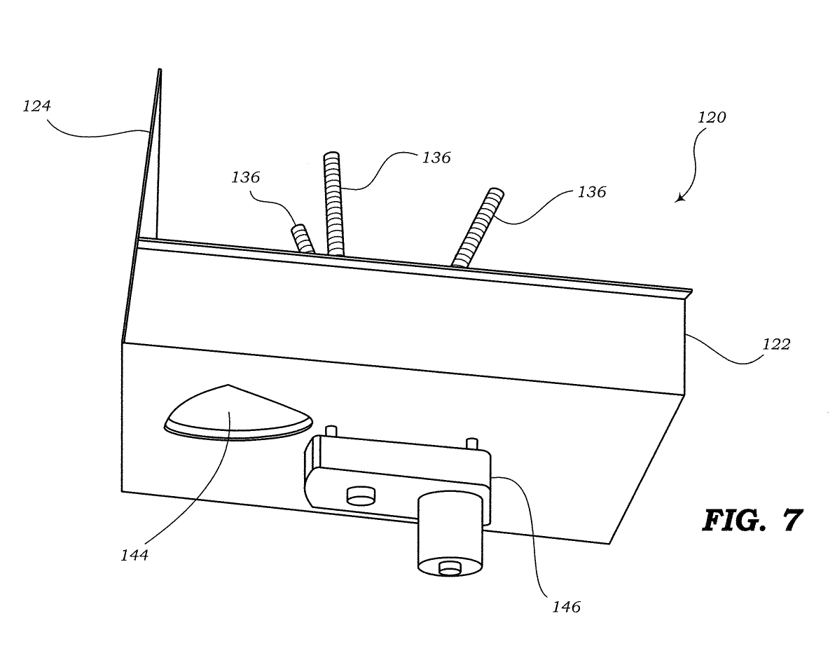

Each vending unit 12 also includes a dispensing mechanism, one embodiment of which is described below with respect to FIGS. 6 and 7. The dispensing mechanism may have an actuator that is configured to dispense the merchandise 20 from the container 18 to the buyer. The front and/or sides of the containers 18 may contain windows 22A, 22B, 22C, and 22D, respectively, allowing a buyer to see the merchandise within the vending units 12.

User interface components may also be positioned on a front face of the vending units 12. For example, each vending unit 12 may include a corresponding price display device 24 configured to display the price that has been set for that respective vending unit 12. The price display devices 24A, 24B, 24C, and 24D may be in electrical communication with circuitry, which sets the price for each vending unit 12, and control devices, wherein the price setting circuitry and control devices may be housed in the pedestal unit 14. When prices are set, as described in more detail below, electrical signals may be sent to the price display devices 24 to cause them to display the price for the merchandise 20 in the vending units 12. In some embodiments, instead of a price display device 24 for each vending unit 12, the vending machine 10 may include a substrate on which the price may be written or printed, a card holder for holding price cards, a price sticker, a mechanical display having adjustable digits, or other display means for indicating the price.

The vending units 12 further include selector buttons 26A, 26B, 26C, and 26D, which may be positioned on the corresponding vending unit 12 and may be near the corresponding containers 18 to simplify the buyer's selection of the desired merchandise. Positioning the selector buttons 26 directly on each vending unit 12 may help to reduce the chance of buyer selection error since there is a one-to-one correlation between the merchandise and the button. This one-to-one correlation is advantageous over conventional vending machines, which may require a buyer to correlate merchandise in certain rows and column of the machine with various key combinations on a keypad and then correctly press the keys of a user interface to select the desired merchandise. In some embodiments, the selector buttons 26 may be aligned vertically with a center of the corresponding vending unit 12 and/or window 22. In addition, the vending units 12 further include merchandise dispensing trays 28A, 28B, 28C, and 28D, wherein, when a selector button 26 is pressed, the dispensing mechanism of the corresponding vending unit 12 is configured to dispense merchandise from the selected vending unit 12 into the corresponding merchandise dispensing tray 28. The merchandise dispensing trays 28 may be configured with or without a lid and may be configured to hold the merchandise 20 until it can be retrieved by the buyer.

In some embodiments, one or more of the vending units 12 may be configured to dispense flat items (e.g., temporary tattoos, stickers, collector cards, stamps, lottery tickets, etc.). For example, in the embodiment shown in FIG. 1, vending unit 12C is configured to dispense flat items. The actuator and merchandise dispensing tray 28C for this vending unit 12C may be replaced by an ejection mechanism that is configured to provide a given number of flat items at a time.

As illustrated in FIG. 1, the vending units 12 may have any suitable width and be configured to dispense any size or type of merchandise. In this respect, the dimensions of the vending units 12 may be configured to dispense various types of merchandise. In addition, the vending machine 10 may include any number of vending units 12 arranged in any order. The vending units 12 and their respective components may therefore be interchanged or arranged during a design stage according to the particular needs of the owner.

Configured to provide support for the vending units 12, the pedestal unit 14 also mounts various components on a front panel thereof. The mounted components may include portions that are exposed for public access, while other portions of the components may be secured within an interior space of the pedestal unit 14. The pedestal unit 14 also houses various circuitry and portions of the mounted components to protect sensitive or private elements from access by the public. For example, the vending machine 10 may include a currency storage device, which may be mounted within the interior space of the pedestal unit 14 and configured to store currency received from the buyers until it may be collected by an authorized operator.

The embodiment of FIG. 1 illustrates that the pedestal unit 14 supports a currency acceptor 30, which may be positioned on a front panel or any suitable side of the pedestal unit 14. The currency acceptor 30 comprises a bill acceptor 32 and a coin acceptor 34 for accepting various types of currency. The pedestal unit 14 also includes a currency display device 36 that displays the amount of currency that the buyer has entered into the currency acceptor 30. In some embodiments, the currency display device 36 may display the balance remaining after a purchase has been made. If the buyer wishes to have the currency returned, the buyer may press a currency return button 37, which is configured to cause a coin return mechanism housed within the pedestal unit 14 to return the buyer's change via a coin return tray 38 and/or to cause the bill acceptor 32 to return the buyer's bills. The coin return mechanism and bill acceptor 32 may also be configured to return an amount of currency exceeding the price set for a selected item.

The front panel of the pedestal unit 14 also includes a lock 40 that prevents access to the interior space of the pedestal unit 14. When the price for the merchandise 20 in one or more of the vending units 12 is to be adjusted, an operator having a corresponding key to the lock 40 may open the front panel of the pedestal unit 14 to access price setting circuitry, which is described in greater detail below.

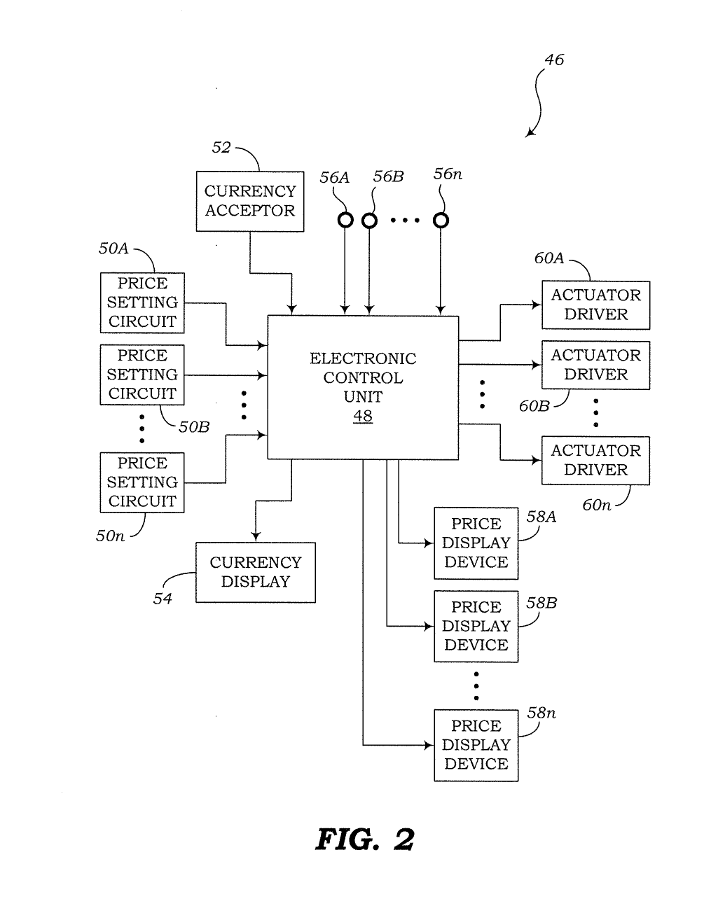

FIG. 2 is a block diagram of an embodiment of vending circuitry 46 that may be incorporated in any suitable vending machine (e.g., the vending machine 10 of FIG. 1). The vending circuitry 46 is configured to provide the electrical functions of the vending machine 10, such as managing the exchange of currency, enabling the prices of each vending unit 12 to be set, displaying the prices for the merchandise 20 in each vending unit 12 (which may be optional in some implementations), and actuating a dispensing mechanism of a selected vending unit 12 to dispense merchandise. The vending circuitry 46 comprises an electronic control unit 48, which is configured to be in electrical communication with the other elements of the vending circuitry 46.

The electronic control unit 48 may be a general-purpose or specific-purpose processor or microcontroller for controlling the operations and functions of the vending circuitry 46. In some implementations, the electronic control unit 48 may include a plurality of processors for performing different functions. The electronic control unit 48 may also include memory devices, such as fixed storage units, removable storage units, and/or remotely accessible storage units, each including a tangible storage medium. The memory devices may include any combination of volatile memory and non-volatile memory and may be configured to store any combination of information, data, instructions, software code, etc.

As illustrated in FIG. 2, the vending circuitry 46 includes price setting circuits 50A, 50B . . . 50n, where “n” represents the number of vending units 12 in the vending machine 10. Each price setting circuit 50 corresponds to a respective vending unit 12 and is configured to set the price for the merchandise for that vending unit 12. The number n may range from one to about eight, depending on the particular design of the vending machine. In some embodiments, the vending circuitry 46 may include more price setting circuits 50 than vending units 12, whereby, in this case, the extra price setting circuits 50 may simply be disregarded. The output settings or values of the price setting circuits 50 are supplied to the electronic control unit 48 for processing. The price setting circuits 50 are inaccessible to the public, but may be adjusted by an authorized operator, as described in more detail below.

More specifically, each price setting circuit 50 includes at least one switch, dial, button, or other electrical device having a manually adjustable component. For example, when the price setting circuits 50 are configured with switches, the switches may include dual in-line package (DIP) switches, slide switches, rocker switches, a rotary switch, toggle switches, key switches, thumbwheel switches, knife switches, a stepping switch, or any other suitable type of switch, set of switches, dials, or other electrical or electromechanical switches or devices having mechanically adjustable components. These devices may have electrical contacts to allow switching between two states, or, in the case of rotary switches, stepping switches, or other types of devices having more than two electrical contacts, switching among a plurality of states.

In addition to price setting circuits 50, the vending circuitry 46 of FIG. 2 further includes a currency acceptor 52 (such as the currency acceptor 30 shown in FIG. 1) and a currency display 54 (such as the currency display 36 shown in FIG. 1). The vending circuitry 46 also includes selectors 56A, 56B . . . 56n (such as the selector buttons 26 shown in FIG. 1), price display devices 58A, 58B . . . 58n (such as the price display devices 24 shown in FIG. 1), and actuator drivers 60A, 60B . . . 60n, where “n” may represent the number of vending units in the vending machine. The actuator drivers 60 are configured to send a drive signal to an actuator of a dispensing mechanism corresponding to the respective vending unit.

The embodiment of FIG. 2 shows that the price setting circuits 50, currency acceptor 52, currency display 54, selection buttons 56, price display devices 58, and actuator drivers 60 are electrically coupled to the electronic control unit 48. The electronic control unit 48 receives inputs from the price setting circuits 50 indicating the price set for each vending unit, currency input signals from the currency acceptor 52 indicating the amount of currency received from the buyer, and selection signals from the selectors 56 indicating which vending unit has been selected.

In response to signals indicating the prices established by the price setting circuits 50 for each respective vending unit 12, the electronic control unit 48 is configured to send signals to each price display device 58 to display the respective prices. In response to the currency input signals received from the currency acceptor 52, the electronic control unit 48 is configured to send signals to the currency display 54 to display the amount of currency received. In response to receiving an indication of selection from one of the selectors 56, the electronic control unit 48 is configured to determine if the accepted currency is equal to or greater than the price for the selected vending unit. If the currency covers the cost, then the electronic control unit 48 sends a signal to one of the actuator drivers 60 corresponding to the selected vending unit. This actuator driver 60 powers an actuator corresponding to a dispensing mechanism of the selected vending unit to cause that vending unit to dispense the merchandise to the buyer.

Before the vending machine is installed for public use, the price setting circuits 50 may be set to certain default values for the prices of each vending unit 12 or they may be initially set by an authorized operator. After installation, the price setting circuits 50 may be changed by the authorized operator at any time as needed.

Referring again to FIG. 1, the lock 40, securely mounted on the outside of the housing of the vending machine 10, allows access to the interior space of the housing of the pedestal unit 14 only by an authorized operator having a compatible key. The lock 40 is configured to prevent tampering with the interior components by unauthorized people. The electronic control unit 48, price setting circuits 50, and actuator drivers 52 shown in FIG. 2 are positioned within the interior space of the housing. Portions of the currency acceptor 52, currency display 54, selection buttons 56, and price display devices 58 are mounted on an outside surface of the housing to create a user interface, while other portions of these components are positioned in the interior space of the housing. Furthermore, a currency storage device (not shown) may reside within the interior space and may be configured to receive the currency accepted by the currency acceptor 52.

The vending circuitry 46 of FIG. 2 may be implemented in hardware, software, firmware, or any combinations thereof. If implemented in software or firmware, according to some embodiments, the vending circuitry 46 may be stored on a memory device and executed by a suitable instruction execution system. If implemented in hardware, the vending circuitry 46 may be implemented using discrete logic circuitry, an application specific integrated circuit (ASIC), a programmable gate array (PGA), a field programmable gate array (FPGA), or any combinations thereof. In some embodiments, the vending circuitry 46 may be embodied on a computer-readable medium for use by an instruction execution system or device, such as a computer-based system. The computer-readable medium may be any medium that is configured to contain, store, communicate, propagate, or transport programs for execution by the instruction execution system or device.

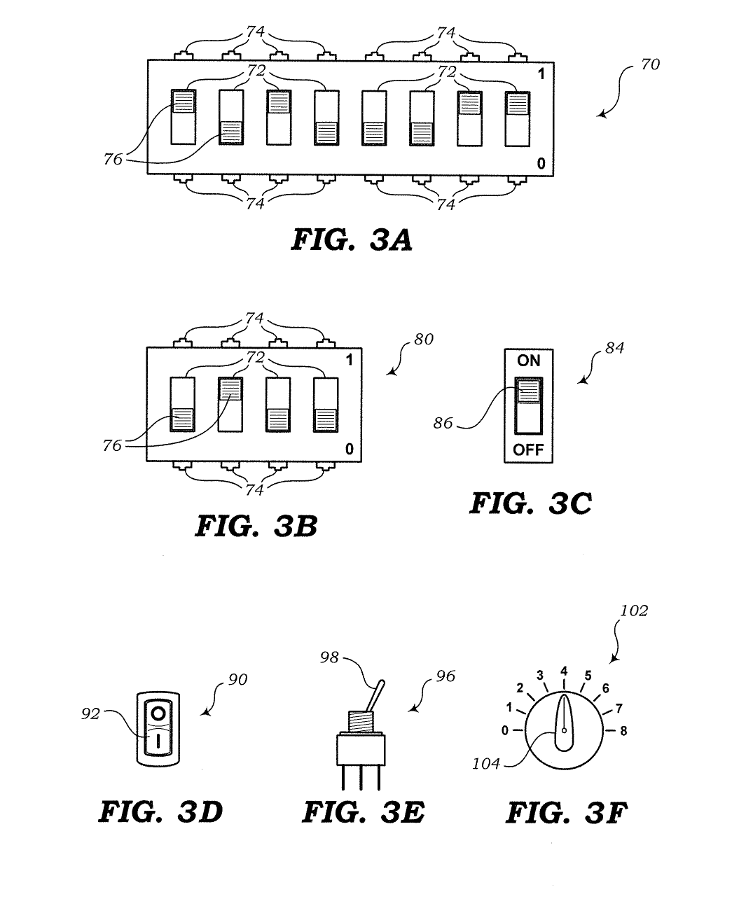

FIGS. 3A through 3F are diagrams of various embodiments of switches that may be incorporated in the price settings circuits 50 shown in FIG. 2. FIG. 3A illustrates a dual in-line package (DIP) switch 70 having eight switches 72 and sixteen pins 74. Each switch 72 includes a manually adjustable component 76 for enabling an operator to set the switch 72 in one of two states, where one state is an “on,” “high,” “closed circuit,” “enabled,” or “one” state and the other is an “off,” “low,” “open circuit,” “disabled,” or “zero” state. FIG. 3B illustrates a DIP switch 80 having four switches 72 and eight pins 74, each switch 72 having a manually adjustable component 76 adjustable between two states. FIG. 3C illustrates a slide switch 84 having a manually adjustable component 86 switchable between two states. FIG. 3D illustrates a rocker switch 90 having a manually adjustable component 92 switchable between two states. FIG. 3E is a toggle switch 96 having a manually adjustable component 98 switchable between two or more states. FIG. 3F is a rotary switch 102 having a manually adjustable component 104 that may be adjusted to one of a plurality of switch positions. For example, the manually adjustable component 104 may be set to one of nine different positions. The rotary switch 102 may be configured to provide an analog signal to the electronic control unit 48, where the analog signal represents the setting of the manually adjustable component 104.

The price setting circuits 50 shown in FIG. 2 may include any combination of one or more of the switches of FIGS. 3A through 3F. To allow the operator to select a price from among four different price settings, two switches may be used to provide four different binary combinations. To allow selection from among eight price settings, three switches may be used. To allow selection from among 16 price settings, four switches may be used. The number of switches incorporated in the price setting circuits 50 therefore determines the number of possible price settings from which the operator may choose.

Some embodiments of the price setting circuits 50 may be configured to enable the operator to select a price from among 16 different price selections. To allow 16 choices, four switches each configurable in two different states may be used such that there would be 16 different binary combinations. The DIP switch 80 of FIG. 3B, for example, may be used in this case because it contains four switches. In other embodiments, four switches 72 of the DIP switch 70 of FIG. 3A may be used for allowing 16 different combinations, while the other four switches 72 may be used for setting the price for another vending unit. The switches of FIGS. 3C, 3D, and 3E include a single switch and may be combined with the same type or different types of other switches to bring the total number of switches up to four. In some embodiments, the number of possible prices may be a factor of the number (or multiples of the number) of selection outputs from a rotary switch (e.g., the rotary switch 102 of FIG. 3F) or other switch having more than two states. The price setting circuits 50 may be configured using any various switch or switches having any number of poles and throws.

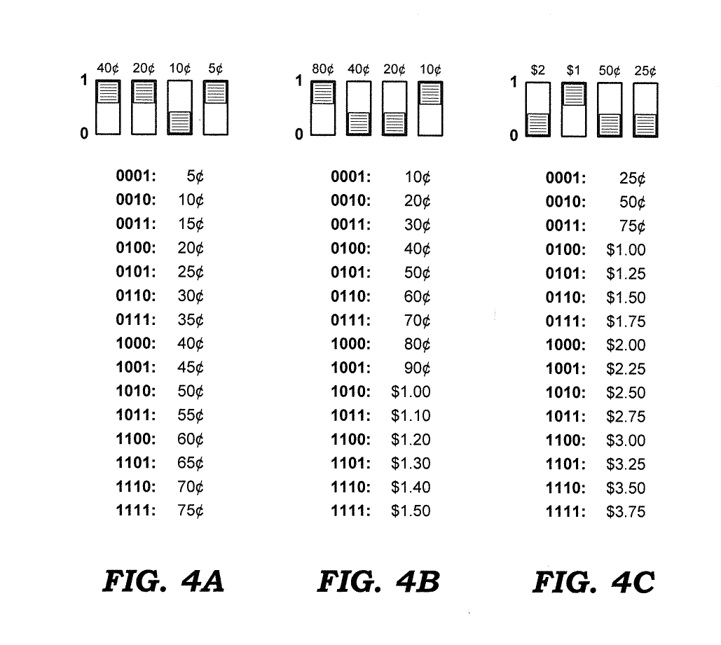

FIGS. 4A through 4C show examples of various price settings where the price setting circuit 50 is implemented with four switches. In FIG. 4A, the combination of four switches (e.g., a DIP switch having four switches) is shown where the manually adjustable component of each switch may be positioned in one of two states, shown here as “0” or “1”. According to this embodiment, the least significant switch represents “5¢,” the second least significant switch represents “10¢,” the third least significant switch represents “20¢,” and the most significant switch represents “40¢.” Labels indicating the different price values for the switches may be attached near the switches to help the operator adjust the price appropriately. The 16 binary combinations (excluding 0000 for “0¢”) are shown such that when the switch is in the “1” position, that value is added to the price. Other implementations of utilizing the 16 different binary combinations by the electronic control unit 48 may be realized by one of ordinary skill in the art having an understanding of the present disclosure. In the implementation as shown, the binary combination 1101, for example, represents 650. Utilizing the pricing scheme mentioned herein, the price for the merchandise of the corresponding vending unit may therefore be set to any value from 5¢ to 75¢ in increments of 5¢.

FIG. 4B illustrates the same combination of switches, but in this embodiment, the switches represent different price values. In this case, the switches represent “10¢,” “20¢,” “40¢,” and “80¢” from the least significant switch to the most significant. The prices for the corresponding vending unit may therefore be set to any value from 10¢ to $1.50 in increments of 100. FIG. 4C illustrates another embodiment having individual switch setting of 25¢, 50¢, $1.00, and $2.00, allowing any price in the range from 25¢ to $3.75 in increments of 25¢.

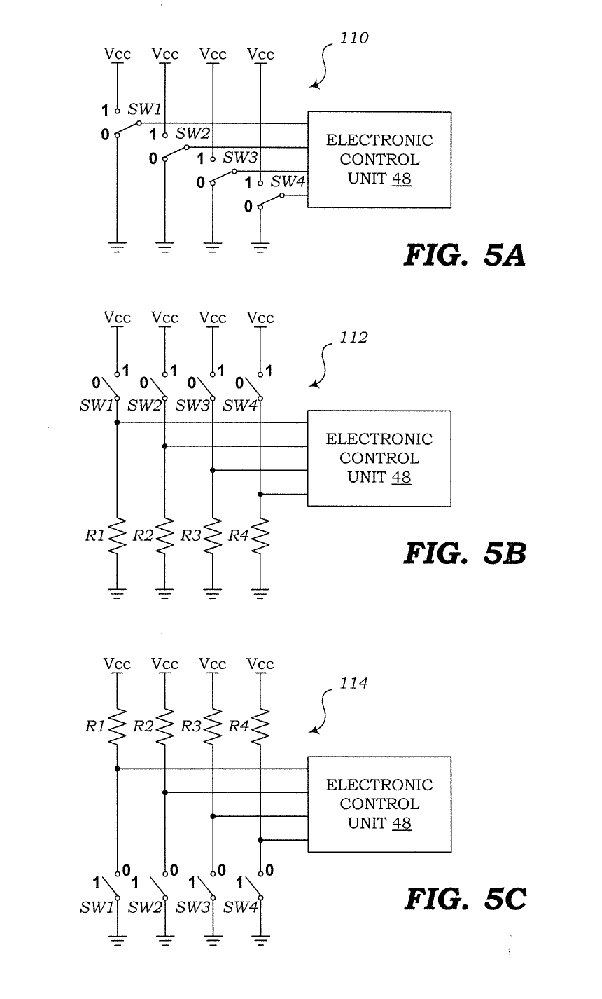

FIGS. 5A through 5C illustrate embodiments of various price setting circuits that may be used for any one or more of the price setting circuits 50 shown in FIG. 2. The price setting circuits in these embodiments may include any number of switches as needed. Although four switches are illustrated (along with corresponding resistors, if any) in the price setting circuits as shown, it should be understood that the circuits may include any number of switches/resistors based on the number of price selections that are to be available to the operator. As explained above, the maximum number of possible price value settings for a price setting circuit is equal to the square of the number of switches/resistors.

A price setting circuit 110 of FIG. 5A includes switches SW1, SW2, SW3, and SW4 having a single-pole double-throw arrangement. When a switch is set to “0,” the corresponding input into the electronic control unit 48 will be low (i.e., grounded). Otherwise, if the switch is set to “1,” the corresponding input into the electronic control unit 48 will be high (i.e., supply voltage Vcc). To prevent the inputs of the electronic control unit 48 from floating, the manually adjustable components of the switches should be positioned in one of the two states to make proper electrical connectivity with the contact of the respective lead. The electronic control unit 48 may be configured to interpret the binary inputs according to predetermined criteria, such as any of the formats used with respect to FIGS. 4A through 4C or other pricing formats. For example, with respect to values shown in FIG. 4A, if the electronic control unit 48 receives inputs (from top to bottom) of high, low, low high (binary 1001), the electronic control unit 48 interprets this setting as the price of 45¢.

In FIG. 5B, a price setting circuit includes switches SW1, SW2, SW3, and SW4 and pull-down resistors R1, R2, R3, and R4, each resistor corresponding to a respective switch. The switches are configured as on/off (i.e., single-pole single-throw) switches. The pull-down resistors are connected between the inputs to the electronic control unit 48 and ground. When a switch is in the off (or open circuit) position, the corresponding pull-down resistor maintains a default value of “0” at the input to the electronic control unit 48. When the switch is in the on (or closed circuit) position, the input to the electronic control unit 48 is coupled to supply voltage Vcc.

FIG. 5C illustrates an embodiment of another price setting circuit 114. In this embodiment, switches SW1, SW2, SW3, and SW4 are configured as on/off switches and pull-up resistors R1, R2, R3, and R4 are connected between the inputs to the electronic control unit 48 and the supply voltage Vcc. When a switch is in the off (or open circuit) position, the corresponding pull-up resistor maintains a default value of “1” at the input to the electronic control unit 48. However, when the switch is in the on (or closed circuit) position, the input to the electronic control unit 48 is coupled to ground and receives a “0” binary value.

FIG. 6 is diagram illustrating a perspective top side view of a dispensing mechanism 120, according to various implementations. In this embodiment, the dispensing mechanism 120 includes a frame 122 and a vertical shield 124 attached at a bottom end thereof to one side of the frame 122. The vertical shield 124 may be positioned in the window 22 to block the view of the dispensing mechanism from the buyer. Fixed within the frame 122 is a sloped channel 126 configured to direct bulk merchandise toward a dish 128 by the force of gravity. A hub 130 is located in a middle portion of the dish 128. The hub 130 may be formed with the dish 128 or may be attached to the dish 128. The hub 130 may have an axis that is concentric with an axis of the dish 128. The dish 128 and hub 130 are configured to rotate with respect to the frame 122 and sloped channel 126 in either a clockwise or counter-clockwise direction. As illustrated in FIG. 6, the dish 128 includes three receptacles 132, but according to other embodiments, it may contain any suitable number. The receptacles 132 may have a size and/or shape that conform to the size and shape of various types of merchandise to be dispensed. Merchandise directed into the receptacles 132 is supported from underneath by a fixed bottom portion of the frame 122.

Securely mounted on the hub 130 is a plate 134 that is configured to support agitators 136. As illustrated, the plate 134 is generally triangular and supports three agitators 136, where the base of each agitator 136 is secured to one of the three corners of the plate 134. From their bases, the agitators 136 are oriented at an angle leading away from the axis of the hub 130. A nut 138 or other fastening device may be used to secure the dish 128, hub 130, and plate 134 together.

The dispensing mechanism 120 further includes a dispenser cap 140 that is positioned over a hole in the base of the frame 122. The dispenser cap 140 allows only one item (or a set of items) to be dispensed at a time. Because of gravitational force, the motion of the dish 128, and the stirring motion of the agitators 136, the items may be redistributed until one item (or set of items) fills each receptacle 132. When actuated, the dish 128 is configured to rotate by a predetermined angle to position a receptacle 132 over the hole. The item (or items) in this receptacle 132 fall through the hole in the frame 122 into, for example, the merchandise dispensing tray 28 shown in FIG. 1. When the emptied receptacle 132 is rotated past the dispenser cap 140, the receptacle 132 may be filled with another item. The agitators 136 help to redistribute the merchandise throughout the container without damaging the items. For example, the agitators 136 may comprise flexible coils to provide sufficient pressure on the items without exerting too much force that might cause the merchandise to break.

FIG. 7 is a diagram illustrating the embodiment of the dispensing mechanism 120 of FIG. 6 from a bottom view perspective. The dispensing mechanism 120 further includes a hole 144 in the bottom portion of the frame 122. The hole 144 may be positioned under the dispensing cap 140 shown in FIG. 6 and allows the merchandise to be dispensed in predetermined amounts. The dispensing mechanism 120 also comprises an actuator 146, which may be driven by the corresponding actuator driver 60 shown in FIG. 2. When a signal is received from the actuator driver 60, the actuator 146 causes the dish 128 to rotate by a certain angle, such as 120° for the embodiments including three equally spaced receptacles 132. The actuator 146 may comprise a motor and a gear system for actuating the rotation of the dish 128. In some embodiments, the actuator 146 may be a direct drive device in which a motor connects directly to the dish 128 without gears or other reductions.

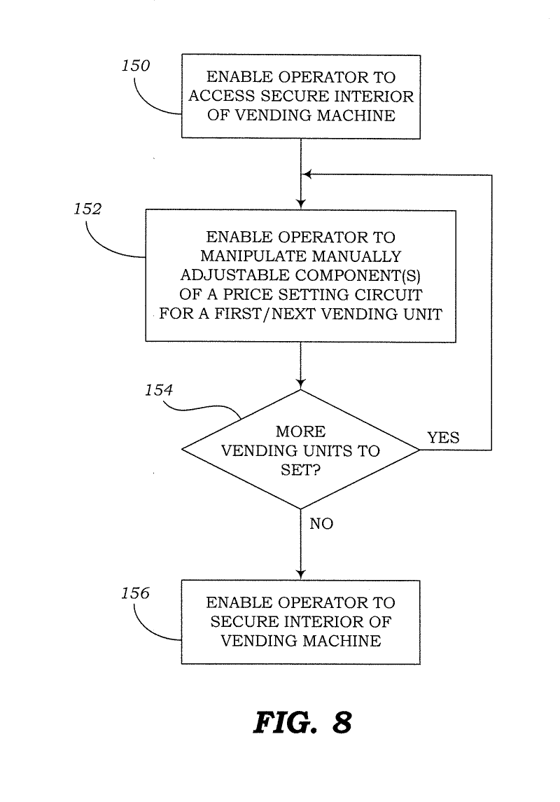

FIG. 8 is a flow diagram illustrating an embodiment of a method for setting prices for a vending machine. The vending machine (e.g., vending machine 10) may have a plurality of vending units (e.g., vending units 12). Each vending unit may be configured to dispense a certain type of merchandise. The method of FIG. 8 may be executed in association with the vending machine 10 of FIG. 1 and/or with any other components described with respect to FIGS. 1-7.

As indicated in block 150, the method includes enabling an operator to access a secure interior space of a vending machine. For example, price setting circuits (e.g., price setting circuits 50) may reside in this interior space. The operator may be able to access the interior space using a key to a lock, entering a combination on a combination lock, or by other security means. As indicated in block 152, the method includes enabling the operator to manipulate manually adjustable component(s) or other mechanical elements associated with a price setting circuit dedicated to a first vending unit. In some implementations, the manually adjustable components may be elements for toggling switches between two different states. The manually adjustable component(s) may be switch-type elements, dial-type elements, buttons, or other adjustable elements of electrical devices that are configured to provide two or more distinct electrical signals indicating two or more different states. According to some embodiments, for example, the electrical devices may be a set of switches on a DIP switch where each switch includes a manually adjustable component. By manipulating the state of the manually adjustable components, the operator essentially is able to set a specific price for the first vending unit.

Decision block 154 indicates that if there are additional vending units for which the price is to be set, then the method returns back to block 152 to allow the operator to manipulate the adjustable components for the additional vending units. This process can be repeated as often as necessary until all the prices for the vending units have been set appropriately. If no more vending units are to be set, the method proceeds to block 156. As indicated in block 156, the operator is enabled to secure the interior of the vending machine, such as by locking a lock to prevent unauthorized access.

It should be emphasized that the above-described embodiments are merely examples of possible implementations. Many variations and modifications may be made to the above-described embodiments without departing from the principles of the present disclosure. All such modifications and variations are intended to be included herein within the spirit and scope of the present disclosure and protected by the following claims.

What is claimed is:

1. A vending machine comprising:
a plurality of vending units, each vending unit including a container configured to store merchandise specific to the respective vending unit, each vending unit also including a dispensing mechanism configured to dispense the merchandise from the container to a buyer;
a plurality of price setting circuits inaccessible to the public, each price setting circuit configured to set the price for the merchandise of a respective vending unit, each price setting circuit including at least one switch having a manually adjustable component;
a currency acceptor configured to accept currency from the buyer; and
a control unit in communication with the price setting circuits and currency acceptor, the control unit configured to actuate the dispensing mechanism of a selected vending unit when a received amount of currency by the currency acceptor is equal to or greater than the price set by the respective price setting circuit for the merchandise of the selected vending unit.

2. The vending machine of claim 1, further comprising a plurality of selector buttons, wherein each selector button corresponds to a respective vending unit and is located near the container of the respective vending unit.

3. The vending machine of claim 1, further comprising a plurality of electronic price display devices, each electronic price display device configured to display the price set for the respective vending unit.

4. The vending machine of claim 1, further comprising a housing and a lock, the price setting circuits and control unit being secured within an interior space of the housing, the lock configured to prevent unauthorized access to the interior space of the housing.

5. The vending machine of claim 4, further comprising a currency storage device mounted within the interior space of the housing, the currency storage device configured to receive the currency accepted by the currency acceptor.

6. The vending machine of claim 1, further comprising a currency display device configured to display the received amount of currency.

7. The vending machine of claim 1, wherein each container includes a window allowing the buyer to view the merchandise stored within the respective container.

8. The vending machine of claim 1, wherein each vending unit includes a dispensing tray configured to hold the merchandise dispensed from the respective container.

9. The vending machine of claim 1, further comprising a coin return mechanism configured to return an amount of currency exceeding the price set for the selected vending unit.

10. The vending machine of claim 1, wherein each price setting circuit includes one of a set of dual in-line package (DIP) switches, a set of slide switches, a set of rocker switches, a rotary switch, a set of toggle switches, a set of key switches, a set of thumbwheel switches, a set of knife switches, or a stepping switch.

11. The vending machine of claim 10, wherein each price setting circuit further includes a resistor for pulling a voltage that is input to the control unit to a supply voltage or ground.

12. The vending machine of claim 1, wherein the dispensing mechanism comprises an actuator configured to rotate a dish having multiple receptacles.

13. The vending machine of claim 12, wherein the actuator is configured to drive the dish by a direct drive technique.

14. Electrical circuitry for vending merchandise, the electrical circuitry comprising:
an actuator driver configured to control a dispensing mechanism associated with a vending unit for dispensing merchandise from the vending unit to a buyer;
an electronic price setting circuit configured to set the price for the merchandise of the vending unit, the electronic price setting device including at least one manually adjustable component;
a currency acceptor configured to accept currency from the buyer; and
an electronic control unit arranged in electrical communication with the actuator driver, electronic price setting circuit, and currency acceptor, the electronic control unit configured to receive an actuation signal;
wherein the electronic control unit is further configured to provide a control signal to the actuator driver when an amount of currency received by the currency acceptor is equal to or greater than the price set for the vending unit.

15. The electrical circuitry of claim 14, wherein, in response to receiving the control signal, the actuator driver is configured to drive the dispensing mechanism to dispense merchandise.

16. The electrical circuitry of claim 14, further comprising a currency display device configured to display the amount of currency received by the currency acceptor.

17. The electrical circuitry of claim 14, further comprising:
a plurality of actuator drivers, each actuator driver configured to control a dispensing mechanism of a respective vending unit; and
a plurality of electronic price setting circuits, each electronic price setting circuit configured to set the price for the merchandise for a respective vending unit;
wherein the actuation signal is a selection signal for selecting one of the vending units; and
wherein the electronic control unit is further configured to provide a control signal to the actuator driver associated with the selected vending unit when the received amount of currency is equal to or greater than the price set for the selected vending unit.

18. The electrical circuitry of claim 17, further comprising a plurality of selector buttons, wherein each selector button corresponds to a respective vending unit and is configured to provide a signal indicating selection of the respective vending unit.

19. The electrical circuitry of claim 17, further comprising a plurality of electronic price display devices, each electronic price display device corresponding to a respective vending unit and configured to display the price set for the respective vending unit.

20. The electrical circuitry of claim 17, wherein the price setting circuits and electronic control unit are mounted within an interior space of a lockable housing to prevent tampering.

21. A method of setting prices for a vending machine, the method comprising:
enabling an authorized operator to access a secured interior portion of the vending machine, the vending machine having a plurality of vending units for dispensing various types of merchandise;
enabling the authorized operator to manipulate one or more mechanical elements of a first set of switches of a first price setting circuit for a first vending unit;
repeating, as needed, the process of enabling the authorized operator to manipulate one or more mechanical elements of additional sets of switches of additional price setting circuits for additional vending units until the prices for the plurality of vending units are set appropriately;
enabling the authorized operator to secure the interior portion of the vending machine to prevent unauthorized access.

22. The method of claim 21, wherein enabling the authorized operator to manipulate one or more mechanical elements of a set of switches further comprises:
providing dual in-line package (DIP) switches, each DIP switch having a sliding element; and
enabling the authorized operator to manipulate the sliding elements of DIP switches.

23. The method of claim 21, wherein each set of switches includes four switches providing 16 different price setting configurations.
